(19) United States
(12) Patent Application Publication
(10) Pub. No.: US 2008/0115471 A1
(43) Pub. Date: May 22, 2008

(54) Substrate, Such as a Glass Substrate, Bearing a Layer with Photocatalytic Properties Which has Been Modified to Absorb Photons in the Visible Spectrum

(75) Inventors: Laurent Labrousse, Saint Prim (FR); Lethicia Gueneau, Vincennes (FR); Nicolas Nadaud, Gentilly (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GOBAIN GLASS FRANCE, Courbevoie (FR)

(21) Appl. No.: 11/547,795

(22) PCT Filed: Apr. 7, 2005
(86) PCT No.: PCT/FR05/50214

§ 371 Date: Oct. 26, 2007

(30) Foreign Application Priority Data
Apr. 9, 2004 (FR) 0450728

(51) Int. Cl. B32B 15/16; B05D 3/04; B01D 50/00; B32B 17/06

(52) U.S. Cl. 55/385.3; 427/377; 428/432; 55/385.1; 55/385.6

(57) ABSTRACT

The invention relates to a method of modifying a layer having photocatalytic and anti-fouling properties which is based on titanium dioxide (TiO₂) and which can absorb photons in the UV region and, in particular, in the UVA region, in order to render same capable of absorbing photons in the visible spectrum, said TiO₂-based layer being applied to a substrate either directly or with the insertion of at least one functional sub-layer. The invention is characterised in that the TiO₂-based layer is subjected to a heat treatment in an atmosphere comprising nitrogen or nitrogen and at least one reducing gas for a sufficient period of time in order to obtain the desired visible photon absorption property, said substrate and, if necessary, said sub-layer(s) having been selected for their ability to withstand the heat treatment.

The present invention relates to substrates, such as glass, ceramic or glass-ceramic substrates, or substrates made of architectural materials or fibrous materials, which have been provided with a coating having a photocatalytic property so as to confer what is called an “antisoiling” or “self-cleaning” function thereon.

One important application of these substrates relates to glazing, of possibly very diverse applications, from utilitarian glazing to glazing used in household electrical appliances, from glazing for vehicles to architectural glazing and glazing for urban furniture, and components of illumination devices.

It also applies to reflective glazing of the mirror type (mirrors for dwellings, or vehicle rear-view or wing mirrors) and to opacified glazing of the safety wall or curtain wall type. It also applies to inorganic or organic ophthalmic lenses.

The invention also applies, similarly, to nontransparent substrates, such as ceramic substrates or any other substrate that can be used in particular as architectural material (metal, paving, tiles, stone, cement compositions, facade render, concrete slabs, architectonic concrete, terracotta, slate, etc.). It preferably applies, irrespective of the nature of the substrate, to substrates that are substantially flat or curved.

Mention may also be made of substrates formed from glass fibers, quartz fibers, silica fibers, etc., which are applied to the filtration of air or water, or employed in bactericidal applications, glass insulation wool, or textile glass reinforcing yarns.

Photocatalytic coatings have already been studied, especially those based on titanium oxide at least partially crystallized in anatase form. Their ability to degrade soiling of organic origin or microorganisms under the effect of UV radiation, in particular UVA radiation (wavelength: 315-400 nm), is highly advantageous. They also often have a hydrophilic character, which allows mineral soiling to be removed by spraying with water or, in the case of outdoor glazing, by the rain.

The activity of optionally doped TiO₂ under the effect of UV radiation, initiating radical reactions resulting in the oxidation of organic compounds, is therefore very satisfactory for degrading organic soiling, but this activity is dependent on its exposure to UV radiation. This is why the self-cleaning activity to the interior of a building, where very little UVA radiation penetrates, or to artificial light is practically nonexistent.

The present invention provides a solution to this drawback and proposes, for this purpose, simple, effective, hazard-free and nonpolluting means for modifying the TiO₂-based film so as to allow it to also absorb photons in the visible (400-800 nm range). It therefore becomes possible to gain in activity, on the one hand because the activity is no longer limited to the degradation of soiling under UV but extends to the degradation of soiling in the visible, and, on the other hand, because this activity can be increased both under UV and in the visible.

The subject of the present invention is therefore firstly a method of modifying a film with a photocatalytic antisoiling property, based on titanium dioxide (TiO₂), capable of absorbing photons in the UV, particularly UVA, region, so as to make it also capable of absorbing photons in the visible, said TiO₂-based film being applied to a substrate either directly or with interposition of at least one functional subfilm, characterized in that said TiO₂-based film is subjected to a heat treatment in a nitrogen atmosphere or an atmosphere containing nitrogen and at least one reducing gas, for a period of time sufficient to obtain the desired property of absorbing photons in the visible, said substrate and where appropriate said subfilm(s) having been chosen so as to be capable of withstanding said heat treatment.

The subject of the present invention is also a process for manufacturing a substrate, especially a glass substrate, bearing on at least part of at least one of its faces, a film having a photocatalytic antisoiling property, based on titanium dioxide (TiO₂), which has been applied to the substrate either directly, or with interposition of at least one functional subfilm, characterized in that a heat treatment is carried out on the substrate bearing said TiO₂-based film in a nitrogen atmosphere or an atmosphere containing nitrogen and at least one reducing gas for a period of time sufficient to make the TiO₂-based film, which is naturally capable of absorbing photons in the UV region, also capable of absorbing photons in the visible and/or to enhance the photocatalytic property of said TiO₂-based film.

Thus, a TiO₂-based film applied to a substrate chosen from glass substrates, surface-dealkalized glass substrates, ceramic or glass-ceramic substrates and substrates of architectural material may be treated, it being possible for said substrates to be in the form of plates, whether plane or having curved faces, and whether monolithic or laminated, or else in the form of fibers, which may form a woven substrate, a nonwoven substrate, etc.

In particular, a TiO₂-based film applied to the substrate with interposition of at least one functional subfilm chosen from:
subfilms grown heteroepitaxially from said TiO₂-based film, as described, for example, in French patent application FR 03/50729;
subfilms that form a barrier to the migration of alkali metals and are used in the case of glass or ceramic or glass-ceramic substrates;
subfilms having an optical functionality;
thermal control subfilms; and
conducting subfilms,
   may be treated.

The migration of alkali metals, as mentioned earlier, may result from applying temperatures in excess of 600° C. Such films forming a barrier to alkali metals during subsequent heat treatments are known, and mention may be made of SiO₂, SiOC, SiOₓN_{y} and Si₃N₄ films, with a thickness for example of at least 5 or 10 nm, and in many cases at least 50 nm, as disclosed in PCT international application WO02/24971.

The films having an optical functionality are especially films for providing the following functions: antireflection; light radiation filtration; coloration; scattering; etc. Examples that may be mentioned include SiO₂, Si₃N₄, TiO₂, SnO₂ and ZnO films.

The thermal control films are especially solar control films or what are called “low-E (low-emissivity)” films.

The conducting films are especially heating, photovoltaic, antenna or antistatic films. These films may include arrays of conducting wires.

According to the present invention, it is possible to treat a film based on titanium dioxide consisting of TiO₂ alone; or of TiO₂ combined with a binder, such as an essentially mineral binder comprising at least one semiconducting metal oxide (titanium oxide, tin oxide, antimony oxide, zinc oxide, tungsten oxide, cobalt oxide, nickel oxide, a mixed cobalt nickel oxide, these optionally being doped, a mixed oxide chosen from manganites and cobaltites, zirconium oxide and aluminum oxide, these optionally being doped (WO 02/92879); or of TiO₂ alloyed with, for example, the same oxides as those mentioned above; or doped TiO₂, for example doped with at least one dopant chosen especially from N, niobium, tantalum, iron, bismuth, cobalt, nickel, copper, ruthenium, cerium, molybdenum, vanadium and zirconium (EP 850 204).

The dopants or alloying elements may be found in the same crystal lattice as TiO₂ as interstitial elements or as substitution elements.

The TiO₂-based film may have been deposited by a sol-gel process or by a pyrolysis process, especially gas pyrolysis of the CVD type, or by room-temperature vacuum sputtering, possibly magnetron sputtering and/or ion beam sputtering, using a metal (Ti) or TiOₓ target (where x<2) and an oxidizing atmosphere, or using a TiO₂ target and an inert atmosphere.

The TiO₂ film may especially be deposited by vacuum sputtering, possibly magnetron and/or ion beam sputtering, under DC or AC supply conditions, under a pressure of 1-3 mbar and in an atmosphere containing oxygen+inert gas, such as argon, using a Ti or TiOₓ (x=1.5 to 2) target.

The TiO₂ produced by sputtering, because it is subjected to the heat treatment according to the invention, is in the crystallized state in a photocatalytically active form (at least partly anatase) even if at the start it was not in this form. In fact, initially the TiO₂ may be amorphous or partially or completely crystallized in anatase or rutile or anatase/rutile form.

According to the present invention, a TiO₂-based film having a thickness in particular of at most 1 μm, especially 5 nm to 1 μm and in particular 5 nm to 800 nm may be treated. In the case of a TiO₂-based film deposited by a sol-gel technique, the thickness may be from 5 to 800 nm. In the case of a TiO₂ film deposited by pyrolysis, the thickness may be from 5 to 200 nm. In the case of a film deposited by sputtering, the thickness may be from 5 to 200 nm.

The heat treatment according to the invention may advantageously be carried out at a temperature of at least 250° C. and possibly up to 700° C. If the substrate is a glass substrate, the heat treatment may correspond to an annealing treatment or to a toughening treatment carried out on said glass substrate, or else to a bending/toughening treatment carried out on a glass substrate that includes a photocatalytic film on face 4 and a solar-protection or low-emissivity (thermal control) film on face 3, in a double-glazing unit in which the faces are denoted 1-2-3-4, face 4 being turned toward the interior of the building.

The heat treatment according to the invention may be carried out under a pressure of 1 atmosphere (1.013×10⁵ Pa).

According to the invention, the heat treatment is advantageously carried out for a period of time ranging from fractions of a second (flash annealing) to several hours. A person skilled in the art will know how to adjust the treatment time according to the parameters, such as thickness of the TiO₂-based film, treatment temperature, glass thickness, etc.

Thus, mention may be made, for example, of a treatment time of 4 to 8 minutes at 500° C., with a 4° C./min temperature rise in order to reach the temperature hold, and a natural descent after the temperature hold in order to return to ambient temperature, in the case of a TiO₂-based film deposited by magnetron sputtering. Mention may also be made of a treatment time of 2 hours at 450° C. with a temperature rise of 100° C./30 min in order to reach the temperature hold, in the case of a TiO₂-based film deposited by the sol-gel process.

As already indicated, a heat treatment may be carried out at a temperature of around 700° C., which corresponds to a toughening treatment, in which case the substrate undergoes rapid cooling thereafter. A person skilled in the art will know how to adapt the process parameters in order to avoid, by excessive or excessively long heating, the TiO₂ from crystallizing in the wrong (rutile) form, and insufficient or excessively short heating, which then does not produce the desired effect.

According to the present invention, at least one gas taken from hydrogen and hydrocarbons, such as methane, is preferably used as reducing gas, the nitrogen/reducing gas volume ratio being especially between 100/0 and 50/50. In the case of mixtures, mention may be made of nitrogen/reducing gas volume ratios from 99/1 to 50/50, in particular 95/5 to 90/10, especially for N₂/H₂.

The present invention also relates to a substrate, especially a glass substrate, bearing, on at least one part of at least one of its faces, a film having a photocatalytic antisoiling property, based on titanium dioxide (TiO₂), which has been applied to the substrate either directly, or by interposition of at least one functional subfilm, said TiO₂ film having been modified by the method as defined above, or said substrate having been manufactured by the process as defined above.

Said substrate may include at least one functional or protective overfilm, such as a film of SiO₂, SiOC, SiO₂:Al, or Pd, Pt or Ag metal islands.

The present invention also relates to the following applications:
application of the essentially transparent substrate to the manufacture of self-cleaning, especially antifogging, antisoiling and anticondensing, glazing, especially glazing for buildings, of the double-glazing type, glazing for vehicles, of the automobile windshield, rear window or side window type, glazing for trains, aircraft and ships, utilitarian glazing, such as aquarium glass, shop window glass or greenhouse glass, glazing for interior furnishings, glazing for urban furniture, mirrors, screens for display systems of the computer, television or telephone type, electrically controllable glazing, such as electrochromic, liquid-crystal or electroluminescent glazing, photovoltaic glazing, and components, such as covers, of illumination devices;
application of the substrate, made of architectural material, to the manufacture of partitions, curtain walling, roofing or flooring, either for indoors or outdoors;
application of the substrate, based on mineral insulation wool and a textile substrate based on glass reinforcing fibers, to the manufacture of false ceilings or filtration materials; and
application of a woven, nonwoven, knitted, braided or block substrate consisting of sintered fused-silica fibers, washed-glass fibers, alumina fibers or mullite fibers, to the manufacture of odor absorption filters, filters for decontaminating industrial effluents, bacterial filters, interior decontamination filters, domestic air purification filters, filters for purifying passenger compartments of transport vehicles, namely automobiles, trains, aircraft and ships, filters for purifying cigarette smoke and filters for purifying household electrical systems.

The following examples illustrate the present invention without however limiting the scope thereof.

### EXAMPLE 1

### Glass/SiO₂:Al/TiO₂ Stack

A 150 nm thick SiO₂:Al film and a 100 nm thick TiO₂ film were deposited on glass plates 4 mm in thickness by magnetically enhanced (magnetron) sputtering under the following conditions:
SiO₂:Al film from an Si:Al target, with a supply in pulsed mode (40 kHz change-of-polarity frequency) under a pressure of 2×10⁻³ mbar (0.2 Pa), a power of 2000 W, and 14 sccm Ar/16 sccm O₂; and
TiO₂ film from a TiOₓ target, with a DC biased supply, under a pressure of 24×10⁻³ mbar (2.4 Pa), a power of 2000 W and 200 sccm Ar/2 sccm O₂.

### EXAMPLE 2

### Stack Annealing in Various Atmospheres

The plates prepared in Example 1 were placed in a chamber with a controlled atmosphere, either air or nitrogen or nitrogen/hydrogen (N₂/H₂=95/5 v/v) and the heat treatment was carried out for various times (up to 16 minutes) and at atmospheric pressure and at 500° C., with a 4° C./min temperature rise, and a natural cooling.

The various plates were then studied.

### EXAMPLE 3

### Results

### Evaluation of the Photocatalytic Activity

The photocatalytic activity of the TiO₂ film on the various plates of example 2 was evaluated according to the stearic acid photodegradation test (SAT) followed by infrared transmission, as described in PCT international application WO00/75087.

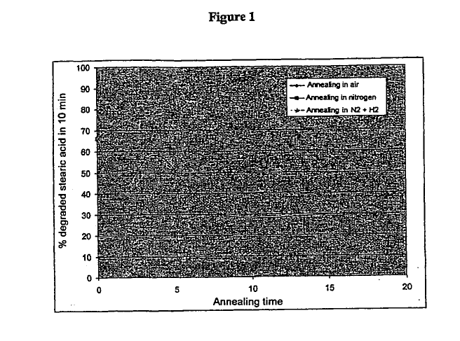

The results are given in FIG. 1, which plots the percentage of degraded stearic acid after 10 minutes of exposure to UV lamps (50 W/m² in the UVA) for various annealing times in the annealing atmospheres, in air (control), in N₂ and in N₂+H₂.

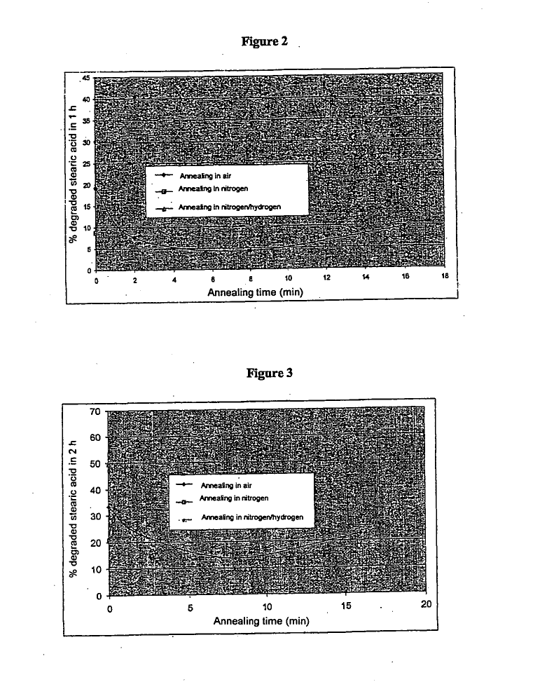

This same activity was evaluated by the SAT after 1 hour or 2 hours exposure to tubes essentially emitting in the visible (conventional illumination lamps (neon tubes) with 1.4 W/m² in the UVA), the results being given in FIG. 2 (1 hour) and FIG. 3 (2 hours).

### Comparison of the Absorption Spectra

Comparison of the absorption spectra for the various types of annealing, in air, in N₂ and in N₂+H₂, shows differences in absorption according to the treatment atmosphere.

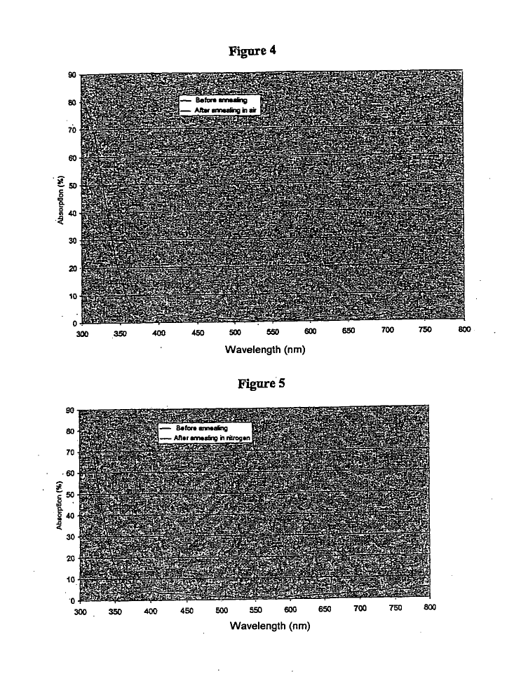

FIG. 4: Comparison of the absorptions before and after annealing for 8 minutes in air for a stack containing 100 nm of TiO₂.

FIG. 5: Comparison of the absorptions before and after annealing for 8 minutes in nitrogen for a stack containing 100 nm of TiO₂.

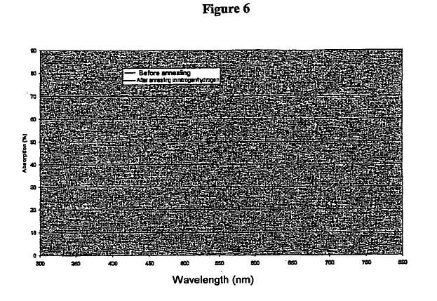

FIG. 6: Comparison of the absorptions before and after annealing for 8 minutes in nitrogen/hydrogen for a stack containing 100 nm of TiO₂.

For annealing in air, the absorptions before and after heat treatment are the same. However, after annealing in nitrogen or nitrogen/hydrogen, the absorption increases after heat treatment in the start of the visible spectrum.

These results show that it is possible to obtain photoactivity in the visible at useful levels for self-cleaning applications indoors for stacks containing simply 100 nm of TiO₂, provided that the heat treatment is carried out in a nitrogen or nitrogen/reducing gas atmosphere.

1. A method of modifying a film with a photocatalytic antisoiling property, based on titanium dioxide (TiO₂), capable of absorbing photons in the UV, particularly UVA, region, so as to make it also capable of absorbing photons in the visible, said TiO₂-based film being applied to a substrate either directly or with interposition of at least one functional subfilm, comprising subjecting said TiO₂-based film to a heat treatment in a nitrogen atmosphere or an atmosphere containing nitrogen and at least one reducing gas, for a period of time sufficient to obtain the desired property of absorbing photons in the visible, said substrate and where appropriate said subfilm(s) having been chosen so as to be capable of withstanding said heat treatment.

2. The method as claimed in claim 1, wherein the treated film is a TiO₂-based film applied to a substrate chosen from glass substrates, surface-dealkalized glass substrates, ceramic or glass-ceramic substrates and substrates of architectural material, it being possible for said substrates to be in the form of plates, whether plane or having curved faces, and whether monolithic or laminated, or else in the form of fibers.

3. The method as claimed in claim 1, wherein the treated film is a TiO₂-based film applied to the substrate with interposition of at least one functional subfilm chosen from:
subfilms grown heteroepitaxially from said TiO₂-based film;
subfilms that form a barrier to the migration of alkali metals and are used in the case of glass or ceramic or glass-ceramic substrates;
subfilms having an optical functionality;
thermal control subfilms; and
conducting subfilms.

4. The method as claimed in claim 1, wherein the treated film is a film based on titanium dioxide consisting of TiO₂ alone, or of TiO₂ combined with a binder, or alloyed or doped TiO.

5. The method as claimed in claim 1, wherein the treated film is a TiO₂-based film having a thickness of at most 1 μm, especially 5 nm to 1 μm and in particular 5 nm to 800 nm.

6. The method as claimed in claim 1, wherein a heat treatment is carried out at a temperature of at least 250° C. and possibly up to 700° C.

7. The method as claimed in claim 6, in which the substrate is a glass substrate, wherein the heat treatment corresponds to an annealing treatment or to a toughening treatment carried out on said glass substrate, or else to a bending/toughening treatment carried out on a glass substrate that includes a photocatalytic film on face 4 and a solar-protection or low-emissivity (thermal control) film on face 3, in a double-glazing unit in which the faces are denoted 1-2-3-4, face 4 being turned toward the interior of the building.

8. The method as claimed in claim 1, wherein the heat treatment is carried out for a period of time ranging from a few fractions of a second to several hours.

9. The method as claimed in claim 1, wherein at least one gas taken from hydrogen and hydrocarbons, such as methane, is used as reducing gas, the nitrogen/reducing gas volume ratio being especially between 100/0 and 50/50.

10. A process for manufacturing a substrate, especially a glass substrate, bearing on at least part of at least one of its faces, a film having a photocatalytic antisoiling property, based on titanium dioxide (TiO₂), which has been applied to the substrate either directly, or with interposition of at least one functional subfilm, comprising heat treating the substrate bearing said TiO₂-based film in a nitrogen atmosphere or an atmosphere containing nitrogen and at least one reducing gas for a period of time sufficient to make the TiO₂-based film, which is naturally capable of absorbing photons in the UV region, also capable of absorbing photons in the visible and/or to enhance the photocatalytic property of said TiO₂-based film.

11. The process as claimed in claim 10, wherein the treated film is a TiO₂-based film applied to a substrate chosen from glass substrates, surface-dealkalized glass substrates, ceramic or glass-ceramic substrates and substrates of architectural material, it being possible for said substrates to be in the form of plates, whether plane or having curved faces, and whether monolithic or laminated, or else in the form of fibers.

12. The process as claimed in claim 10, wherein the treated film is a TiO₂-based film applied to the substrate with interposition of at least one functional subfilm chosen from:
subfilms grown heteroepitaxially from said TiO₂-based film;
subfilms that form a barrier to the migration of alkali metals and are used in the case of glass or ceramic or glass-ceramic substrates;
subfilms having an optical functionality;
thermal control subfilms; and
conducting subfilms.

13. The process as claimed in claim 10, wherein the treated film is a film based on titanium dioxide consisting of TiO₂ alone, or of TiO₂ combined with a binder, or alloyed or doped TiO.

14. The process as claimed in claim 10, wherein the treated film is a TiO₂-based film having a thickness of at most 1 μm, especially 5 nm to 1 μm and in particular 5 nm to 800 nm.

15. The process as claimed in claim 10, wherein a heat treatment is carried out at a temperature of at least 250° C. and possibly up to 700° C.

16. The process as claimed in claim 15, in which the substrate is a glass substrate, wherein the heat treatment corresponds to an annealing treatment or to a toughening treatment carried out on said glass substrate.

17. The process as claimed in claim 10, wherein the heat treatment is carried out for a period of time ranging from a few fractions of a second to several hours.

18. The process as claimed in claim 10, wherein at least one gas taken from hydrogen and hydrocarbons, such as methane, is used as reducing gas, the nitrogen/reducing gas volume ratio being especially between 100/0 and 50/50.

19. The process as claimed in claim 10, wherein the TiO₂ film is deposited by room-temperature vacuum sputtering, possibly magnetron sputtering and/or ion beam sputtering, using a metal (Ti) or TiOₓ target (where x<2) and an oxidizing atmosphere, or using a TiO₂ target and an inert atmosphere.

20. The process as claimed in claim 10, wherein the TiO₂ film is deposited by a gas pyrolysis process of the CVD type.

21. The process as claimed in claim 10, wherein the TiO₂ film is deposited by a sol-gel process.

22. A substrate, especially a glass substrate, bearing, on at least one part of at least one of its faces, a film having a photocatalytic antisoiling property, based on titanium dioxide (TiO₂), which has been applied to the substrate either directly, or by interposition of at least one functional subfilm, said TiO₂ film having been modified by the method as defined in claim 1.

23. A self-cleaning, especially antifogging, antisoiling and anticondensing, glazing, especially glazing for buildings, of the double-glazing type, glazing for vehicles, of the automobile windshield, rear window or side window type, glazing for trains, aircraft and ships, utilitarian glazing, such as aquarium glass, shop window glass or greenhouse glass, glazing for interior furnishings, glazing for urban furniture, mirrors, screens for display systems of the computer, television or telephone type, electrically controllable glazing, such as electrochromic, liquid-crystal or electroluminescent glazing, photovoltaic glazing, and components of illumination devices comprising the substrate of claim 22.

24. A partition curtain walling, roofing or flooring, either for indoors or outdoors comprising the substrate of claim 22 made of architectural material.

25. Fake ceilings or filtration materials comprising the substrate of claim 22 based on a mineral insulation wool and a textile substrate based on a glass reinforcing fiber.

26. Odor absorption filters, filters for decontaminating industrial effluents, bacterial filters, interior decontamination filters, domestic air purification filters, filters for purifying passenger compartments of transport vehicles, namely automobiles, trains, aircraft and ships, filters for purifying cigarette smoke and filters for purifying household electrical systems comprising a woven, nonwoven, knitted, braided or block substrate comprising sintered fused-silica fibers, wasted-glass fibers, alumina fibers or mullite fibers of claim 22.
